(19) United States
(12) Patent Application Publication
(10) Pub. No.: US 2003/0158988 A1
(43) Pub. Date: Aug. 21, 2003

(54) Methods, apparatus and software for improving SMI latency on systems using timing-sensitive registers

(76) Inventor: Timothy A. Lewis, El Dorado Hills, CA (US)

Correspondence Address: KIMBERLY G. NOBLES, IRELL & MANELLA LLP, 840 NEWPORT CENTER DRIVE, SUITE 400, NEWPORT BEACH, CA, 92660, US

(21) Appl. No.: 10/081,840

(22) Filed: Feb. 20, 2002

(51) Int. Cl. G06F 13/24

(52) U.S. Cl. 710/260

(57) ABSTRACT

A system, method and software that provides for improved system management interrupt (SMI) latency the present invention includes a real-time clock, and a register file containing one or more timing sensitive registers. An index and data register is provided for accessing the timing sensitive registers in the register file. An update-in-progress status bit determines a certain fixed period of time for which the timing-sensitive registers are valid. A retriggerable, fixed duration timer is triggered by reads of zero from the update-in-progress status bit. A latch is provided that is set if the timer is running when a system management interrupt is asserted and cleared when SMI is deasserted. A mechanism is provided for reading the output status of the latch. A timer is provided that is triggered by reading zero from a first register location. A status latch is provided for storing the status of the timer, which status is read using a status bit. SMI handling code is provided that reads the status latch, and if the status latch is zero, exits the SMI handling code, and if the status latch is non-zero, writes 0A to I/O location 0x70 of a second register location, reads I/O location 0x71 from a third register location, and if bit 7 of the value read from the third register location is set, repeats the previous two steps until the value of bit 7 is not set, and then exits the SMI handling code.

### BACKGROUND

The present invention relates generally to computer systems, methods, and software, and more particularly, to a system, method, and software for improving system management interrupt (SMI) latency on systems using timing-sensitive registers.

There are three significant solutions known to the inventor in the prior art that relate to improve SMI latency on systems using timing-sensitive registers. The first is to ensure that the update-in-progress status bit is clear before exiting an SMI handler.

The second is to require that the code using the real-time-clock registers set some sort of system-wide flag to indicate that the time-sensitive registers are about to be accessed. The SMI handler would then read this flag to determine whether or not to wait for the update-in-progress bit to be clear.

The third is to require that the code using the real-time clock registers read a system-wide flag to determine whether an SMI has occurred after the update-in-progress status bit has been tested but before the data register has been accessed.

Disadvantages of prior art are as follows. The first prior-art solution requires that in 0.1% of SMIs, the additional latency will be up to 1 ms. The second prior-art solution requires that all code adhere to the standard. Unfortunately, quite a bit of legacy code accesses the real-time clock registers without any regard to this standard. The third prior-art solution contains a race condition where, between the reading of the system-wide flag and the access of the data register, an SMI occurs. This code would proceed to access the possibly-corrupted register.

It is therefore an objective of the present invention to provide for systems, methods, and software for improving SMI latency on systems using timing-sensitive registers.

### SUMMARY OF THE INVENTION

To meet the above and other objectives, the present invention comprises systems, methods, and software that improve SMI latency on systems that use timing-sensitive registers. The present invention comprises a real-time clock, a register file containing one or more timing sensitive registers, and an index and data register for accessing the timing sensitive registers in the register file. An update-in-progress status bit determines a certain fixed period of time for which the timing-sensitive registers are valid.

A retriggerable, fixed duration timer is provided that is triggered by reads of zero from the update-in-progress status bit. A latch is provided that is set if the timer is running when a system management interrupt is asserted and cleared when SMI is deasserted. A mechanism is provided for reading the output status of the latch. A timer is provided that is triggered by reading zero from a first register location. A status latch is provided for storing the status of the timer, which status is read using a status bit.

SMI handling code (an SMI handler) is provided that reads the status latch, and if the status latch is zero, exits the SMI handling code, and if the status latch is non-zero, writes 0A to I/O location 0x70, reads I/O location 0x71, and if bit 7 of the value read is set, repeats the previous two steps until the value of bit 7 is not set, and then exits the SMI handling code.

The present invention is based upon the observation that the period of potential danger occurs for ˜1 ms after the read of the update-in-progress status bit with a value of zero. The present invention adds a timer which is triggered by reading zero from register location 0xA, bit 7. The status of the timer (running or not) is stored in a status latch upon assertion of SMI and the latched value can be read by software code (such as the SMI handler) using a status bit. This status bit is the indicator of whether the SMI occurred during this period of potential danger. If the SMI handler was in the critical period, then it must check the update-in-progress bit before proceeding. Otherwise, the SMI handler may exit normally. The status latch is cleared when the SMI is deasserted.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates an exemplary system in accordance with the principles of the present invention; and

FIG. 2 illustrates an exemplary method in accordance with the principles of the present invention.

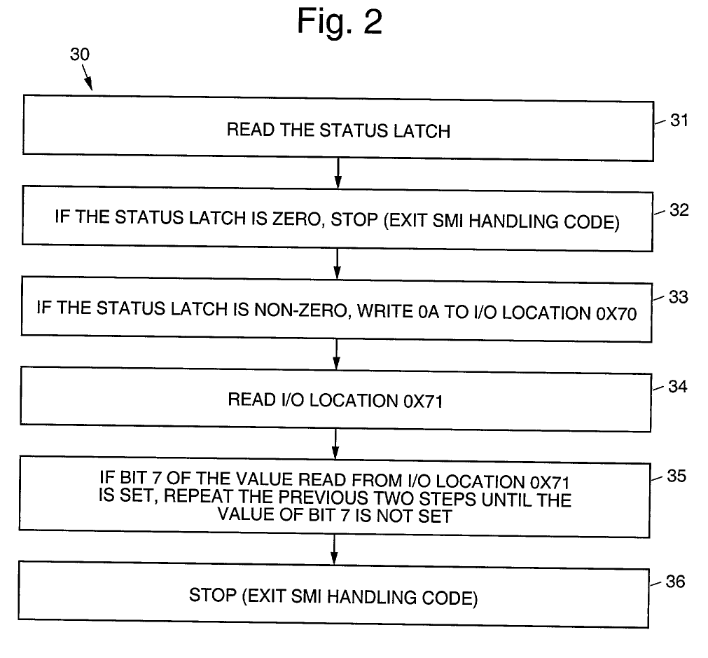

### DETAILED DESCRIPTION

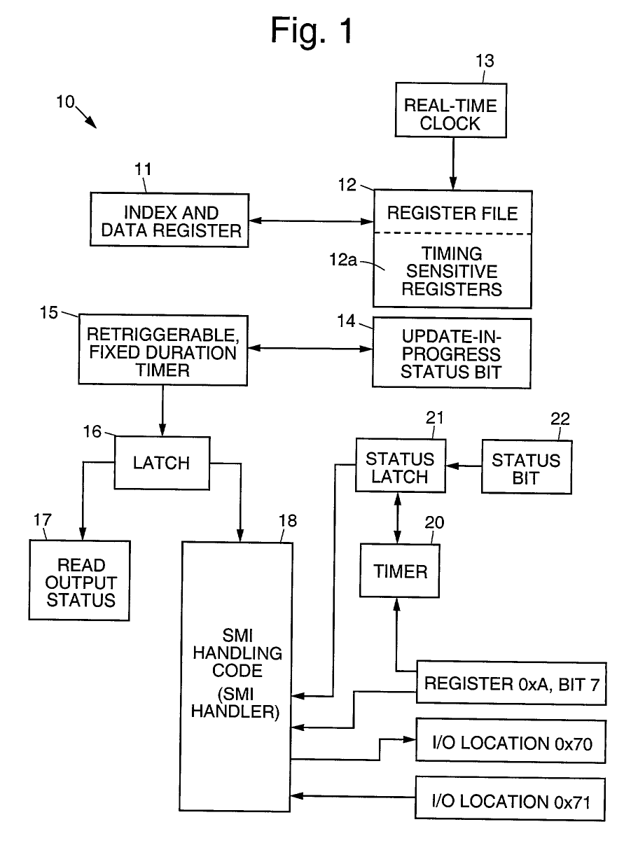

Referring to the drawing figures, FIG. 1 illustrates an exemplary system 10 in accordance with the principles of the present invention. The exemplary system 10 comprises a computer system 10, for example, that logically comprises the following components.

The system 10 includes an index and data register 11. The index and data register 11 is used to access a register file 12 containing one or more timing sensitive registers 12a. For a real-time clock 13 used in the system 10, the register file 12 comprises registers 0-9, which are the date/time registers.

The system 10 includes an update-in-progress status bit 14. The update-in-progress status bit 14 guarantees a certain fixed period of time for which the timing-sensitive registers 12a are valid. For the real-time clock 13 used by the system 10, the update-in-progress is register 10, bit 7, which, when set, guarantees no updates to the date/time registers for at least 244 μs.

The system 10 includes a retriggerable, fixed duration timer 15 that is triggered by reads of zero from the update-in-progress status bit 14. The retriggerable, fixed duration timer 15 has a duration that is fixed at ˜1 ms. This duration depends on the length of the no-update time (˜244 μs, for example) plus the actual update time. If the retriggerable, fixed duration timer 15 expires, it does not restart. The status of the retriggerable, fixed duration timer 15 timer 15, running or not, can be determined. The status of the retriggerable, fixed duration timer 15 may be determined by reading a status register that is contained in a memory-mapped I/O location, I/O register, or PCI configuration register.

The system 10 includes a latch 16, which is set if the retriggerable, fixed duration timer 15 is running when a system management interrupt (SMI) is asserted and cleared when the SMI is deasserted.

The system 10 includes means 17 for reading the output status of the latch 16. This means 17 may include a memory-mapped I/O location, an I/O register, or a PCI configuration register, for example.

The system 10 includes SMI handling code 18 (or SMI handler 18) that checks the status of the output of the latch 16 before determining whether to wait for the update-in-progress bit 14.

In order to update time or date, software running on the system 10 generally performs the following steps.

Step 1 is to write 0A to I/O location 0x70.

Step 2 is to read I/O location 0x71.

In step 3, if bit 7 of the value that is read in step 2 is set, go to step 1.

Step 4 is to write to I/O location 0x70 with the index of the date/time register file 12 (registers 0-9).

Step 5 is to read/write to I/O location 0x71 with the data for the date/time register file 12 (registers 0-9).

Steps 1-3 may require up to 244 μs plus the actual time required for the realtime clock 13 to update its registers. On some implementations, this time may be up to 492 μs plus the actual real-time clock 13 update time. The steps 4 and 5 may not take more than 244 μs in order to avoid writing to the date/time registers 12a at the same time while the real-time clock 13 is trying to update these registers 12a. The total time unavailable may be up to 1 ms.

The system management interrupt (SMI) is the highest priority interrupt in some families of x86 central processing units (CPUs). It cannot be disabled using normal CPU interrupt-prevention mechanisms. There is a boundary condition where an SMI occurs after step 3. Depending on the length of time required to service the SMI, steps 4 and 5 might not be executed until after the 244 μs window of safety has passed, thus causing potential data corruption.

In order to handle this, SMI handlers 18 have been forced to delay returning until after they guarantee that the update status bit is clear. In the worst case, this adds an additional 1 ms to the SMI latency. Since the SMI is the highest priority interrupt in the system 10, all other system services will be delayed until the SMI handler 18 exits, causing, in some cases, unacceptable delays in servicing other device interrupts. Exemplary pseudo-code (implemented in an SMI handler 18) for handling this is as follows:

Step 1 is to write 0A to I/O location 0x70.

Step 2 is to read I/O location 0x71.

In step 3, if bit 7 of the value that is read is set, go to step 1.

Step 4 is to exit the SMI handler 18.

The present invention relies the observation that the period of potential danger occurs for ˜1 ms after the read of the update-in-progress status bit 14 with a value of zero. The present invention adds a timer 20 which is triggered by reading zero from register location 0xA, bit 7. The status of the timer 20 (running or not) is stored in a status latch 21 upon assertion of SMI and the latched value can be read by software code (such as the SMI handler 18) using a status bit 22. This status bit 22 is the indicator of whether the SMI occurred during this period of potential danger. If the SMI handler 18 was in the critical period, then it must check the update-in-progress bit 14 before proceeding. Otherwise, the SMI handler 18 may exit normally. The status latch 21 is cleared when the SMI is deasserted.

The steps of an exemplary method 30 and that is also implemented in software (SMI handler 18) in accordance with the principles of the present invention are as follows.

Step 1 is to read 31 the status latch 21.

In step 2, if the status latch 21 is zero, stop 32 (exit 32 the SMI handler 18).

Step 3 is to write 33 0A to I/O location 0x70.

Step 4 is to read 34 I/O location 0x71.

In step 5, if bit 7 of the value read is set, go 35 (jump 35) to step 3.

Step 6 is to stop 32 (exit 32 the SMI handler 18).

Since the sequence of reading the update-in-progress status bit 14 is rare, the worst-case SMI latency is the same, but the average SMI latency is improved.

Alternative embodiments of the present invention may include other timing-sensitive registers 12a other than those in the real-time clock 13, other means for accessing the contents of the register 12, other than index/data registers 12a, durations other than 1 ms, types of unavailability other than register updates, other means of determining unavailability, and other higher-priority interrupts, including non-maskable interrupts (NMIs).

In previous solutions, an average of 0.1% of SMIs had a delay. In the present invention, assuming normal usage, only 0.001% of SMIs should experience a delay. The improved features of the present invention include latching register availability status at the point when a higher priority interrupt is received by the SMI handler 18.

Thus, methods, apparatus and software for improving SMI latency on systems using timing-sensitive registers have been disclosed. It is to be understood that the described embodiments are merely illustrative of some of the many specific embodiments which represent applications of the principles of the present invention. Clearly, numerous and other arrangements can be readily devised by those skilled in the art without departing from the scope of the invention.

What is claimed is:

1. A system having improved system management interrupt (SMI) latency, comprising:
a real-time clock;
a register file containing one or more timing sensitive registers;
an index and data register for accessing the timing sensitive registers in the register file;
an update-in-progress status bit that determines a certain fixed period of time for which the timing-sensitive registers are valid;
a retriggerable, fixed duration timer that is triggered by reads of zero from the update-in-progress status bit;
a latch that is set if the timer is running when a system management interrupt is asserted and cleared when SMI is deasserted;
means for reading the output status of the latch;
a timer that is triggered by reading zero from a first register location;
a status latch for storing the status of the timer, which status is read using a status bit; and
SMI handling code that reads the status latch, and if the status latch is zero, exits the SMI handling code, and if the status latch is non-zero, writes to a second register location, reads a third register location, and if a predetermined bit of the value read from the third register location is set, repeats the previous two steps until the value of the bit is not set, and then exits the SMI handling code.

2. The system recited in claim 1 wherein the SMI handling code reads the status latch, and if the status latch is zero, exits the SMI handling code, and if the status latch is non-zero, writes 0A to I/O location 0x70, reads I/O location 0x71, and if bit 7 of the value read from O location 0x71 is set, repeats the previous two steps until the value of bit 7 is not set, and then exits the SMI handling code.

3. A method for improving system management interrupt (SMI) latency of a system having timing-sensitive registers, a status latch, and a plurality of I/O locations, the method comprising the steps of:
(1) reading the status latch;
(2) stopping if the status latch is zero;
(3) writing to a first I/O location;
(4) reading a second I/O location;
(5) if a predetermined bit of the value that is read from the second I/O location is set, repeating steps (3) and (4) until the predetermined bit of the read value is not set; and
(6) stopping the method.

4. The method recited in claim 3 which reads the status latch, and stops if the status latch is zero, and if the status latch is non-zero, writes 0A to I/O location 0x70, reads I/O location 0x71, and if bit 7 of the value read from I/O location 0x71 is set, repeats the previous two steps until the value of bit 7 is not set, and then stops.

5. Software for improving system management interrupt (SMI) latency of a system having timing-sensitive registers, a status latch, and a plurality of I/O locations, comprising:
(1) a code segment that reads the status latch;
(2) a code segment that exits if the status latch is zero;
(3) a code segment that writes to a first I/O location;
(4) a code segment that reads from a second I/O location;
(5) a code segment that, if a predetermined bit of the value that is read from the second I/O location is set, repeats steps (3) and (4) until the predetermined bit of the read value is not set to zero; and
(6) a code segment that exits when the predetermined bit of the read value is not set to zero.

6. The software recited in claim 2 which reads the status latch, and stops if the status latch is zero, and if the status latch is non-zero, writes 0A to I/O location 0x70, reads I/O location 0x71, and if bit 7 of the value read from I/O location 0x71 is set, repeats the previous two steps until the value of bit 7 is not set, and then exits.
